(19) United States
(12) Patent Application Publication
(10) Pub. No.: US 2026/0340757 A1
(43) Pub. Date: Oct. 29, 2026

(54) A SIGNAL PROCESSING SYSTEM

(71) Applicant: CUVOS PTY LTD, Sydney, New South Wales (AU)

(72) Inventors: Tara Hamilton, Sydney, New South Wales (AU); Peter Waldeck, Sydney, New South Wales (AU); Andrew Nicholson, Sydney, New South Wales (AU); Benjamin Essam, Sydney, New South Wales (AU)

(73) Assignee: CUVOS PTY LTD, Sydney, New South Wales (AU)

(21) Appl. No.: 19/106,979

(22) PCT Filed: Aug. 25, 2023
(86) PCT No.: PCT/AU2023/050827

§ 371 Date: Feb. 26, 2025

(30) Foreign Application Priority Data
Aug. 26, 2022 (AU) 2022902462

(51) Int. Cl. G06T 1/20; G06T 5/10; G06T 5/20; G06T 5/70; G06T 5/92; G06T 5/94

(52) U.S. Cl. CPC G06T 1/20; G06T 5/10; G06T 5/20; G06T 5/70; G06T 5/92; G06T 5/94; G06T 2207/20208; G06T 2207/20212

(57) ABSTRACT

Disclosed is a signal processing system comprising a plurality of processing modules, the plurality of processing modules being configured to receive signal data characterising information of a common source, and configured to apply processing to the signal data, and provide a processed result as an output, wherein processing applied to the signal data includes temporal processing. The plurality of processing modules in use process separate portions of signal data to improve signal to noise ratio thereof.

### TECHNICAL FIELD

This disclosure relates to a method, device, and system for signal processing.

### BACKGROUND ART

Image processing is an important area given a multitude of applications involve the analysis of data determined from images. It is an important aspect, for instance, of artificial vision.

Artificial vision has developed based predominantly on our understanding of the physics of light and light detection. Thus, traditional imaging techniques have focused on converting the reflected light into colour and intensity values that can be reconstructed into an impressive facsimile of the real-world (through human eyes) scene.

Today's digital imaging technologies are outstanding in quality and accuracy. There are, however, still many gaps in our ability to reproduce the visual performance demonstrated by most animal life on Earth. For instance, the amazing dynamic range of the human eye (and other animal eyes) has been difficult to replicate using our digital technology. This is mainly due to the fact that evolution of the human eye has occurred in a dynamic environment. Early humans (and other animals) needed to be able to see in the first light of the morning and the last light of the night. They were not simply standing still either: humans had to move from high exposure to low light conditions while finding shelter from the weather, hunting animal prey, or hiding from similarly over-specked predators.

Previous efforts to develop high dynamic range vision have either focused on implementation of computer vision algorithms in software or in approximated versions of these on digital hardware. This has contributed significant latency or power consumption and thus, these solutions continue to be refined. Alternative solutions based on animal-inspired eyes (or neuromorphic sensors) have either been very specific on the attribute they wished to demonstrate or involve specialised hardware that requires entirely new ways to process the output signal in order to extract information from it.

There is need for more broadly applicable alternative solutions.

### SUMMARY

In a first aspect, herein disclosed is a signal processing system comprising:
a plurality of processing modules, configured to receive signal data characterising information of a common source, and configured to apply processing to the signal data, and provide a processed result as an output, wherein processing applied to the signal data includes temporal processing;
wherein each of the plurality of processing modules in use process a respective one of separate portions of the signal data to improve signal to noise ratio thereof.

The device can include a recombination module to recombine processed signal data output by the processing modules, to provide an output for the signal processing device.

The plurality of processing modules can be identical.

Each processing module can comprise a plurality of processing stages connected in series.

The processing stages can together implement a neuromorphic processing algorithm.

The input are image data can comprise one or more frames having pixels.

Each separate portion of signal data can include data of a set of pixels, the set of pixels comprising one or more pixels at the same locations in each frame.

Each separate portion can include pixels distributed across the frames.

Signals corresponding to the pixels of the frame can be provided to the plurality of processing modules in turn, where a first pixel in the frame is provided to a first one of the processing modules, and each subsequent pixel is provided to a subsequent one of the of processing modules in turn.

For each frame in the image data, the separate data portions processed by different processing modules can be signals of neighbouring pixels

The set of pixels providing data for each separate data portion can be located in a similar region of the frame.

Processing applied at each processing module can include frequency domain processing.

Each processing module can include at least one processing stage configured to apply a low pass filter or a band pass filter.

Each processing module can include a cascade of filters connected in series.

The signal data is received from multiple data sources, wherein every processing module can be configured to receive data from each of the multiple data sources.

Each data source can be configured to provide a time series of data.

Each processing stage can include multiple filters, respectively operating on data from a corresponding one of the data sources.

The filters in the same processing module can have a same cut-off frequency.

The filters in different processing modules can have different cut-off frequencies.

The plurality of processing modules can have frequency response ranges which continues from each other to generally form an extended frequency response range.

At least one of the plurality of processing modules can have a frequency response range which overlaps with a frequency response range of another one of the plurality of processing modules.

At each processing stage, a filter output at a previous time sample can be subtracted from a filter output at a current time sample.

The common source can provide signal data having variability over time.

The data source can be any one of sources comprising image sensor(s), phased array, antenna(s), audio sensor(s), radio frequency sensor(s), ultrasound sensor(s), inertial sensor(s).

In a second aspect, herein disclosed is a method for processing signals, using a signal processing system. The method comprises providing a data connection between an input source and the signal processing system, so that each of a plurality of different portions of an input signal data will in use be received by a corresponding module of the plurality of modules in the signal processing system to be processed by the module; and combining outputs from the plurality of modules to form recombined frames.

Each processing module can process the same amount or similar amounts of data signals.

The input signal data can include data of one or more time-series of signals.

The signal data at time points in the time-series can be sequentially provided to each processing module in turn.

The input signal data can include data of multiple time-series of signals, wherein signal data at the same time points from the multiple series are provided to the same processing module.

Data from each time-series of signals can be provided to a corresponding one of the processing modules.

The input signal data can be image data comprising frames having pixels. The method can comprise assigning pixels of each frame of the image data into a plurality of pixel subsets, wherein each module processes data of a different one of the pixel subsets.

Each pixel sub-set can include pixels distributed across the frame.

Assigning the pixels of each frame into the plurality of pixel subsets can be performed such that image data of the pixels of the frame are provided to the plurality of modules in turn in accordance with locations of the pixels in the frame, where a first pixel in the frame is provided to a first one of the modules, and each subsequent pixel is provided to a subsequent one of the of modules in turn.

Each pixel sub-set can include pixels from a spatial region of the frame.

In a further aspect, herein disclosed is a signal capture device comprising a signal capture arrangement providing input to a signal processing system mentioned above.

In another aspect, herein disclosed is an apparatus comprising a signal capture device as mentioned above, connected in series to a digital signal processor.

In a further aspect, herein disclosed is an apparatus comprising a signal processing system, for pre-processing an input data, the signal processing system being configured to provide its input to a further signal processor configured to perform further signal processing.

### BRIEF DESCRIPTION OF THE DRAWINGS

Embodiments will now be described by way of example only, with reference to the accompanying drawings in which

FIG. 1 is a screen-shot of a YouTube video (source: https://www.youtube.com/shorts/5NNoq1Gq4sc; accessed 17 May 2022), that shows how a pair of sunglasses does not affect the contrast in the detected image when using a DVS camera;

FIG. 2 is a schematic depiction of a pixel-wise pipelined processing provided by the processing model in accordance with an embodiment of the present invention;

FIG. 3 is an example depicting a pattern of assigning the pixels of a frame to each of four pipelines, where the pattern resembles a checkboard pattern, in accordance with an embodiment of the present invention;

FIG. 4 is another example depicting how the pixels of a frame are assigned to each of nine pipelines, where neighbouring pixels of similar exposure levels are assigned to the same pipeline, in accordance with an embodiment of the present invention;

FIG. 5 is a general schematic of the processing model implemented by an image enhancement device in accordance with an embodiment of the present invention;

FIG. 6 is a schematic depiction of an example of a scaling performed by a divisive filter;

FIG. 7(a) depicts an image acquired using an imager whose output has been enhanced using the enhancement processing model implementing temporal processing in accordance with the present invention;

FIG. 7(b) depicts an image acquired under the same conditions as that shown in FIG. 8(a), but which has not been enhanced using the enhancement processing model implementing temporal processing in accordance with the present invention;

FIG. 8(a) depicts an image acquired indoors under low light using an imager without the enhancement device in accordance with the present invention;

FIG. 8(b) depicts an image acquired under the same conditions as those in which the image in FIG. 8(a) was acquired, with an imager with the enhancement processing model in accordance with the present invention;

FIG. 9(a) depicts an image acquired under bright light using an imager without the enhancement device in accordance with the present invention;

FIG. 9(b) depicts an image acquired under the same conditions as those in which the image in FIG. 9(a) was acquired, with an imager with the enhancement processing model in accordance with the present invention;

FIG. 10 schematically depicts an example “N pipeline” structure processing a single time-series of inputs, in accordance with an embodiment of the present invention, where each pipeline includes a cascade of operations;

FIG. 11 schematically depicts an example of operations performed at each stage in a cascade, including a filtering operation and a differencing operation;

FIG. 12 depicts a frequency response of each virtual pixel representing one stage in a filter cascade similar to a cochlea;

FIG. 13-1 depicts a multiple pipeline structure in accordance with an embodiment of the present invention, each pipeline akin to a silicon cochlea, where each pipeline has a frequency response range which is offset from that of the other pipelines;

FIG. 13-2 depicts a multiple pipeline structure in accordance with another embodiment of the present invention, each pipeline akin to a silicon cochlea, where each pipeline has a frequency response range which continues from the frequency response range of another pipeline;

FIG. 14 depicts a multiple pipeline structure to which an input comprising data from multiple input sources is applied, in accordance with an embodiment of the present invention;

FIG. 15 depicts a multiple pipeline structure to which an input comprising data from multiple input sources is applied, in accordance with another embodiment of the present invention;

FIG. 16 depicts a multiple pipeline structure to which an input comprising data from multiple input sources is applied, in accordance with an embodiment of the present invention;

FIG. 17 schematically depicts a non-linear response which is implemented by a processing module of an embodiment of the invention;

FIG. 18-1 schematically depicts a “broad” non-linear response for a low magnitude sensory environment;

FIG. 18-2 schematically depicts a more compressive non-linear response, comparison to that shown in FIG. 18-1, for a high magnitude sensory environment;

FIG. 19 schematically depicts an image frame where some pixels arrive late or out of order;

FIG. 20 schematically depicts the timing for updating the global parameters and for updating the local parameters, for pixels (x, y), (m, n) and (t, u);

FIG. 21 schematically depicts an arrangement where acquisition of input data to be processed by the processing algorithm is not continuous;

FIG. 22(a) schematically depicts updating of the global parameters by the processing algorithm during a calibration period; and

FIG. 22(b) schematically depicts processing by the processing algorithm during a post-calibration period wherein the global parameters are fixed at their calibrated values.

### DETAILED DESCRIPTION

In the following detailed description, reference is made to accompanying drawings which form a part of the detailed description. The illustrative embodiments described in the detailed description, depicted in the drawings, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

The present invention provides a method and system for an improved model to pre-process input data. The model is implementable in software or in a software-hardware hybrid approach were some of the processes are implemented in hardware and others in software. This is because the inventive approach and principles described herein do not depend on the implementation being in software or hardware. With sufficient processing resources, software implementation may still provide a satisfactory solution, even though the hardware processing is still likely to provide an implementation which is closer to real time.

This processing approach of the input data, prior to feeding the processed data to downstream digital signal processing can reduce the amount of processing required by the digital signal processor.

Compared with the prior art, embodiments of the present invention show that the advantages of bio-inspired signal processing models can be translated to improve the design of digital circuits.

At the most general level, the method disclosed herein involves the application of parallel processing to the input data. However, rather than simply simultaneously processing data from multiple sources, in the present approach, data from the same source are provided to multiple processing pipelines. Each pipeline having processing logic configured to operate on the data input to the pipeline. This approach speeds up the processing of the input data. The pipeline and processing logic may be configured in hardware as mentioned previously.

In preferred embodiments, the processing in each of the multiple pipelines implements temporal processing. For example, this includes a determination of a temporal change in the data. The temporal change may be the change in the processing output, or the processing output at a particular stage of the processing pipeline.

When the input data are images, the device uses the temporal changes in each pixel to enhance the image and extend the camera's dynamic range. Also, rather than simply reporting the change information, embodiments of the present device uses the past pixel values to correct the intensity, thus increasing the dynamic range, without losing other visual information.

The improved implementation may also be applied to other types of input data, such as those comprising one or more temporal series of data.

### Image Enhancement Device

In an embodiment, the pre-processing model according to the present invention provides an improved implementation of a “neuromorphic” approach. In hardware implementation, the image enhancement device utilises a hardware solution in implementing the temporal processing of image data in the neuromorphic approach. However the processing is applicable for software or hybrid implementation.

### Pipeline Based Processing

The method and device according to the present invention provides pipeline based temporal processing, for implementing temporal processing algorithms. This facilitates the performance of image enhancement or correction algorithms while minimising memory and latency.

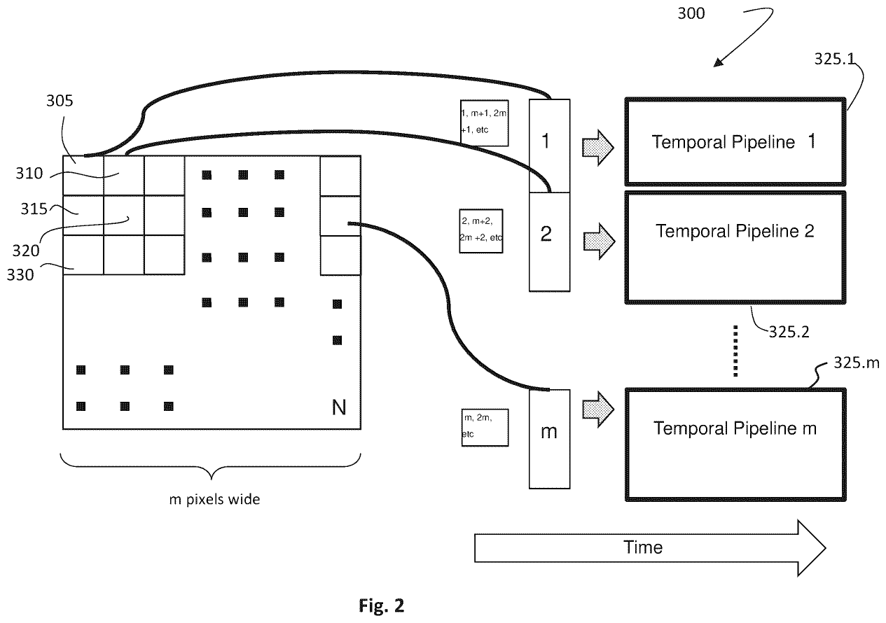

A schematic overview of the pipeline-based processing is illustrated in FIG. 2. The processing is pixel-wise pipelined.

In an embodiment, in order to reduce latency, m parallel pipelines are computed simultaneously. For frames with N pixels, 1≤m≤N. However, in practice, the memory bandwidth of the processing array or processing chip may place another limiting factor on m. In the extreme case of N pipelines, each pixel has its own dedicated pipeline.

The outputs from the multiple pipelines are then recombined to form a processed output. In the case of image data, as each pipeline processes a portion of the image data, the outputs from the multiple pipelines are then combined to reform the frame at the output end. At this point further processing as the skilled person may consider including, such as demosaicking, debayering, and colour space correction, can occur. However, as the skilled person would realise, the further processing may be done at the input side, prior to the data being fed to the pipelines. This would not affect the principles of the concepts disclosed herein.

As shown in FIG. 2, data of the pixels at each frame are sent to a plurality of temporal pipelines 300. Data of pixel 1 (305) is computed in the first pipeline 325.1, then pixel m+1 (315), 2m+1, and so on, are also computed in the first pipeline 325.1. Similarly, pixel 2 (310) is computed in the second pipeline 325.2 , then pixel m+2 (320), 2m+2, and so on, are also computed in the second pipeline 325.2. The m^{th} pixel, and every m^{th} pixel thereafter, are computed in the m^{th} pipeline 325.m. In FIG. 2, there are m pipelines, one for each column for an m-pixel wide frame. However, in other embodiments, this may not be the case.

For each frame, data for multiple pixels designated for the same pipeline will be provided to the pipeline at the same time. Therefore, in the example of FIG. 2, the data of pixels 305 and 330 will be provided to the pipeline 325.1 at the same time.

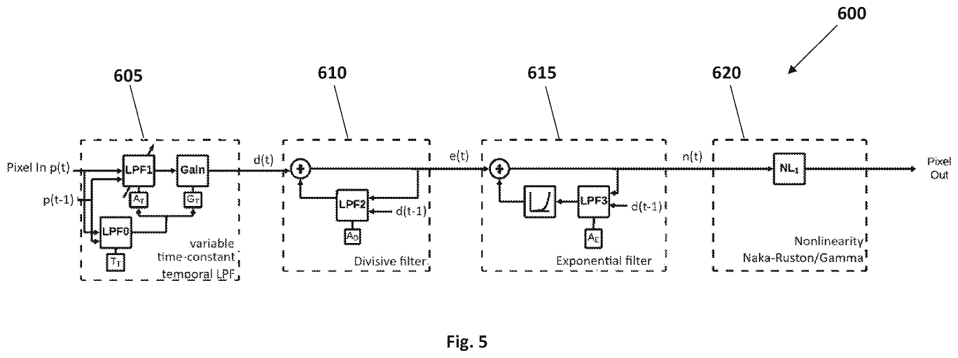

The more pipelines, the more the processing speed is increased. In the limiting case of m=N, this means that each pixel is independent. For example, in an application to correct or enhance a DVS camera image, when m=N, the enhancement or correction performed on the pixel is similar in magnitude to the change that is detected in a DVS camera for a single pixel. Thus, having m<N means that more of the overall exposure of the image is used in the enhancement of the image. However, as will be appreciated by the skilled person, even at m=N, it is still possible to introduce influence from lighting exposures at other pixels, e.g., by introducing regional or even global influence, by choosing globally or regionally determined constants for the filters used for the processing pipelines, as will be later explained with reference to FIG. 5. Another example is the non-linear compression, such as the Naka-Ruston compression which is applied to the output, where intra pixel influences may be considered.

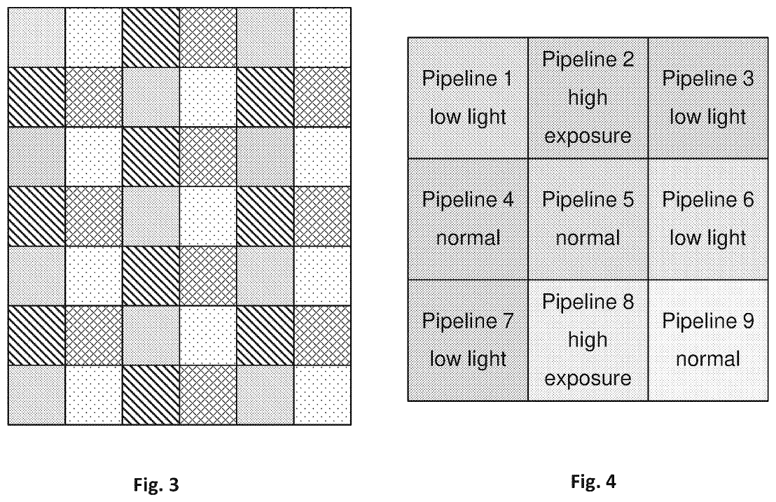

FIG. 3 shows an example pattern formed, when the pixels are assigned to four pipelines in turn. Pixels assigned to the first pipeline are shown in solid colour, and pixels assigned to the second, third, and fourth pipelines are shown in dotted, hatched, and cross-hatched patterns respectively.

Given video frames that each have N pixels, selecting m<N causes the assignment (i.e., mapping) pattern of pixels to pipelines to form what resembles a checkerboard pattern as can be seen from FIG. 3. The assignment of pixels to each of m pipeline is done more than once and possibly may be repeated a few times across the pixels. Thus, the accumulated constants in the pipeline, such as A_{T}, are determined with a statistical sample more representative of the overall frame. That is, utilising m parallel pipelines, where m<N (the total number of pixels), means that the statistical variations within a frame are covered by each pipeline, thus resulting in the accumulated constants such as A_{T}, better representing the overall variation in the scene. Global influences on the image data, e.g., arising from global lighting conditions, sensor settings or limitations, global movement in the sensor(s), can therefore be represented in each pipeline, even though each pipeline only processes a sub-set of the overall spatial data.

There are alternatives to the checkerboard type pattern of pixel to pipeline assignment shown in FIG. 3. For example, if the statistics of the scene are better understood, or where the lighting conditions of the scene are known and stable, the knowledge of the contrast structure could be used to optimise the pipeline assignment, such that separate pipelines would cover pre-set sections of the frame, such as sections which are anticipated to be similarly contrasted regions within the image captured within the frame.

An example of this concept is depicted in FIG. 4. In FIG. 4, the pixels in the frame are assigned to nine pipelines. Each group of pixels assigned to the same pipeline are in a similar region of the frame. For example, each group of pixels are assigned to a similarly contrasted section (i.e., similar expected contrast levels within the overall frame). For instance, the group of pixels at the top left corner of the frame are in a low light section of the frame, and are assigned to pipeline 1. The top middle group of pixels are in a high exposure section of the frame and are assigned to a second pipeline. The top right group of pixels are in a low light section of the frame and thus are assigned to a third pipeline. As illustrated in FIG. 4, each group of pixels appears to cover the same size (i.e., same number of pixels), and each group of pixels is assigned to a different pipeline. These are not essential requirements. It is possible to have two or more disjointed groups in the same pipeline. However, it will be preferred that the different pipelines each have the same or similar numbers of pixels per frame.

In some embodiments, the processing pipelines will process different regions of pixels where the image data are of the same object. This may be important in applications where an understanding of what is being captured in the scene is available.

In some embodiments, the processing pipelines are configured to process the data (e.g., pixels) at different rates. For example, the pipelines are “clocked” at non-identical rates so that they receive the input data at non-identical rates. A pipeline allows the pipelines to process different amounts of data during a given time period. This feature can be useful when there is a varying density of pixel inputs across the visual field. For instance, some image sensing systems can have differently foveated regions, providing more pixel density in one or more parts of the visual field. For example, in a visual field where the peripheral regions are known to be of less interest, the clocking speed for supplying the pixel data from those regions to the signal processing system will be slower.

As an optional feature, statistics determined using the image data across a plurality of frames are used to adjust the spatial assignment of the pixel subsets to the processing pipelines, or where applicable to adjust the clocking speed for sending the data of one or more of the pixel subsets to the processing pipelines, or both.

For example, statistical information identifying a rate of intensity change over a number of frames may be determined. A persistent change in pixel intensity in one or more pixels will cause those pixels to be reassigned as belonging to a higher intensity region, to be sent to pipeline which processes higher intensity image data.

Temporal and/or spatial reassignment of the pixels to the pipelines allows a way utilising the parallel processing in the proposed system to model “attention”. For example, when the attention is to be given to motion of an object, the assignment of pixels to pipelines can change over time, depending on where in the image frame an object is expected to be.

The data from each pixel will be sent to the assigned pipeline for processing. As the pipelines process on a per-pixel basis, multiple processing cycles are be needed per image frame, the number of cycles being dependent on the number of pixels respectively assigned to the pipelines. The outputs from the parallel processing can then be provided for further processing. For example, on a per processed-pixel basis, the output values from the pipelines will be recombined by a recombination module to provide the enhanced image frame. Further processing on the enhanced image frame can be performed by a downstream module such as a digital signal processor (DSP). By enhancing the quality of input to the DSP, it is expected that the processing load by the DSP will be reduced, and/or better output may be achieved by the same DSP algorithm.

Thus, the pipeline-based approach allows for parallel processing of different parts of an entire frame, unlike spatial filtering solutions which are the common way of performing image enhancement on an entire frame together, which is significantly more computationally complex.

In preferred embodiments, each pipeline in the multiple pipeline approach implements temporal processing on the input pixels. However, it will be understood that the precise algorithm involving temporal processing is not a limitation on the multi-pipeline approach itself.

### Bio-Inspired Processing Model

One example of the proposed device implements a bio-inspired or “neuromorphic” processing model for image data, to improve the dynamic range of the imaging sensor.

The processing model, implemented by each processing pipeline included in the device, performs processing including temporal processing—i.e., processing involving samples from different points in time. The aim is to enhance the image based on the temporal components of visual perception.

This temporal component of visual perception is not present in the majority of imaging systems (with the exception of event-based visual sensors—EBS—which only look at change and binarized to positive change, negative change, or no change) and thus, artificial systems have failed, thus far, to demonstrate the versatility of animal eyes. Additionally, “conventional” solutions to develop high dynamic range vision have generally required operations on the entire frame of an image, as spatial information has been key to correcting the images' contrast.

The processing model is applied to image pixels within the same image frame, in each of the multiple processing pipelines. The implementation may be made on an FPGA or other digital hardware to provide a hardware solution. However, it may be implemented in software via processing units such computing system central processing units, or other types of processing units available on the market. For instance, depending on the processing load and other constraints such as budgetary constraints the skilled person may choose processing unit types with more powerful performance for graphics processing, or processing units with capability to deal with a higher amount of data faster. A hybrid approach may also be used.

This embodiment does not implement complex computer vision algorithms on digital hardware, nor does it require a custom imager. Embodiments can be implemented in software using available processing units and computing architectures. Embodiments implemented in FPGA/digital hardware can interface with most CMOS imager technologies. The output from a device provided in accordance with the invention is expected to be compatible with all standard (or non-standard) video/image pipelines and thus, the enhancement that it provides can be obtained without requiring wholescale changes to the video/image system to which it is connected. Embodiments can be implemented in a hybrid approach where some modules are implemented using software and others are using hardware. The result provides capability to process the image with improved efficiency, and potentially in real time or near real time.

The bio-inspired processing model is described below.

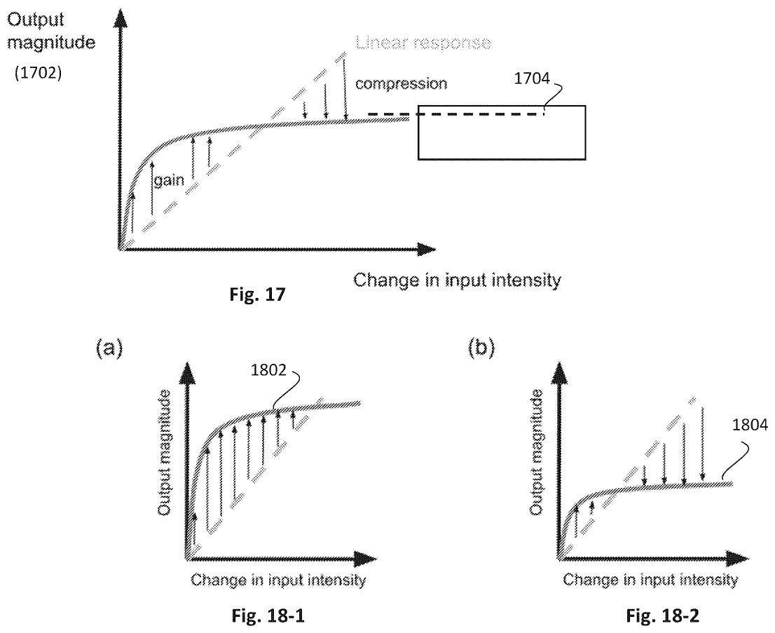

The processing model is inspired by photoreceptor cell models, modified for practical implementation. A top-level block diagram representing the processing model is shown in FIG. 5. As shown in FIG. 5, the processing model 600 comprises 4 stages: a temporal filter 605; a divisive filter 610; an exponential filter 615; and a non-linear compression stage 620. The non-linear compression stage 620 is shown as being implemented using Naka-Rushton/Gamma compression (or an approximation of this compression), but other functions may be used as can be chosen by the skilled person. For example, alternative functions may include hyperbolic tangent or square root functions. The key requirement is that the function asymptotically approaches limiting values, for example as illustrated in FIG. 17.

The input to the processing model comprises pixel values from an imager. i.e., image sensor. For example, the input includes 12-bit pixels from a CMOS (complementary metal-oxide-semiconductor) imager. The input bits are preferably resized to the nearest byte to improve mathematical and memory access efficiency. For example, the 12 bit values may be padded up to 16 bits (2 bytes), or it may be truncated down to 8 bits, as can be chosen by the skilled person and as may be implemented in different embodiments. The CMOS imager outputs RGB (or YCrCb etc.) values and the demosaic algorithm simply corrects these into a single value for each pixel. The per pixel processing helps to reduce latency introduced by the processing.

In the implementation of image enhancement device described here, the above-mentioned algorithms to prepare the input for the processing model can be provided by external Xilinx IP, as an example. Products provided by other vendors may be used, as can be selected by the skilled person. It is, however, possible to develop custom algorithms and these could be combined with the processing model algorithm to improve efficiency even further. Custom algorithms may, for instance, track high or low levels of illumination (or signal intensity more generally), to provide the system with the ability to optimize a region of the image (or, more generally, the input signal). Other algorithms could be used for tracking either objects or changes across the signal (in the case of macro-lighting changes, for example). Thus, specific algorithms to be applied during the pipeline operation are not themselves considered to be limitations of the current invention.

The processing model algorithm is executed as a pipeline, or in multiple pipelines in accordance with the present invention. Pixel data are sent to corresponding channels for processing in a respective processing pipeline.

The processing stages of each pipeline implementing a bio-inspired processing model is briefly described below. The processing stages can be considered to form a cascade, given the sequential nature of the processing stages.

### Temporal Filter

The temporal filter 605 models the temporal characteristics of the photoreceptor cells (hereinafter, the “PRCs”). The temporal filter 605 includes a low-pass filter (LPF) “LPF1” with a variable time-constant. The time-constant of LPF1 is itself modulated by a fixed time-constant LPF (“LPF0”), which is updated based on its previous value or an accumulation of the previous values of surrounding “cells”. The output of the fixed time-constant LPF (“LPF0”) is input for calculating an adaptive time constant 630, and for calculating the gain function 635. The adaptive time constant determination outputs a value A_{T} which is used as the adaptive time-constant for LPF1. A_{T} is an adaptive time constant across multiple image frames and this is a global parameter as already discussed above. The purpose of this time-constant is to correct for intensity changes in the input pixel over time which can cause large variations in the coherence of the output image. For example, the adaptive time constant can be calculated as an average time constant value over the frames at different time points, a weighted sum of the time constant values over the frames at different time points, etc. This exemplifies the use of previous surrounding values to update a current time constant.

The gain function 635 adjusts the gain at the output of LPF1, so that the pixel value exists in a particular range. Here LPF1 is preferably a first order LPF, as it is considered to provide a good balance between adequate PRC approximation, and processing complexity. This helps to reduce or minimise extra memory requirements, which is a bottleneck for any image processing algorithm.

### Divisive Filter

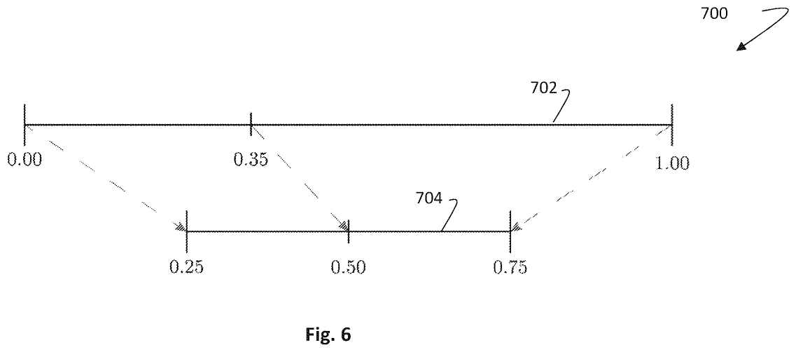

The divisive filter 610 scales the output of the temporal filter 605 to align with the De Vries-Rose Law. This filters out or at least minimises effects of quantal noise from the input. An example of divisive filter scaling is shown in FIG. 6.

### Exponential Filter

The exponential filter 615 implements an automatic gain control (AGC) response such that the filter compresses high magnitude signals and amplifies low magnitude signals. In this example, the exponential filter follows or generally follows Weber's model which modifies the gain based on the intensity of the input and models the behaviour of rods in the retina. Weber's model is chosen because it allows the implementation of the asymptotic approach. Thus, if available, other functions that follows the asymptotic approach may be utilised.

### Nonlinearity Compression

The nonlinearity compression stage 620 compresses the output signal such that it operates in a particular range. This compression is conceptually depicted in FIG. 6, where the non-compressed values from an input range 702 are compressed nonlinearly to the output range 704.

The above-mentioned elements make up the signal processing which is performed on each pixel. Unlike other image enhancement techniques which have been implemented in digital hardware, with hardware implemented embodiment of the present model, performance of spatial operations on the image is not necessary. Rather, the temporal processing provides the image enhancement without need for spatial filtering or other operations. This lack of spatial processing means that it is possible to process the image much more efficiently than previous implementations.

### Results

Image results obtained using an image enhancement device in accordance with an embodiment of the present invention implementing the above-mentioned bio-spired model, in FPGA, will be shown for comparison with image results obtained using a conventional imager.

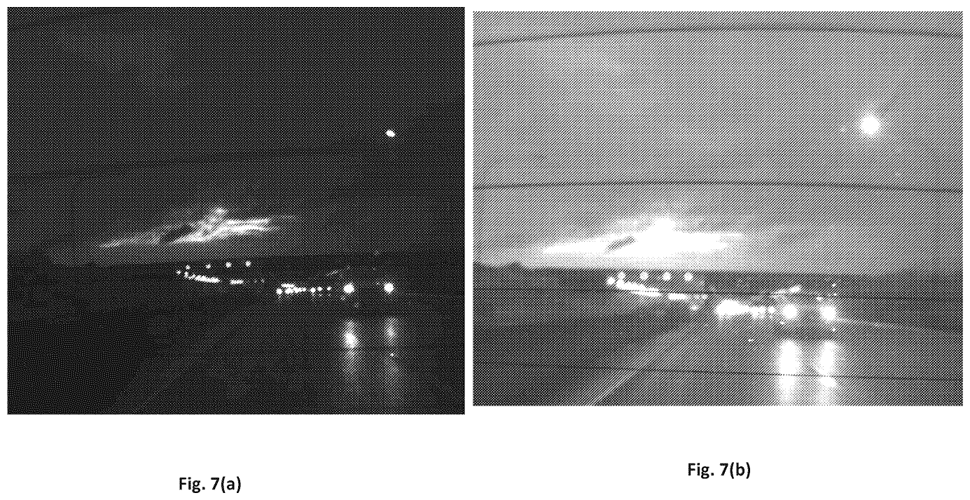

The image enhancement device was measured to work in lighting conditions from 0.4 lux up to 32,000 lux. FIG. 7(a) depicts an image acquired using an imager whose output has not been enhanced using the enhancement processing model implementing temporal processing in accordance with the present invention. FIG. 7(b) depicts an image which has been enhanced. The enhancement processing model used was implemented in FPGA.

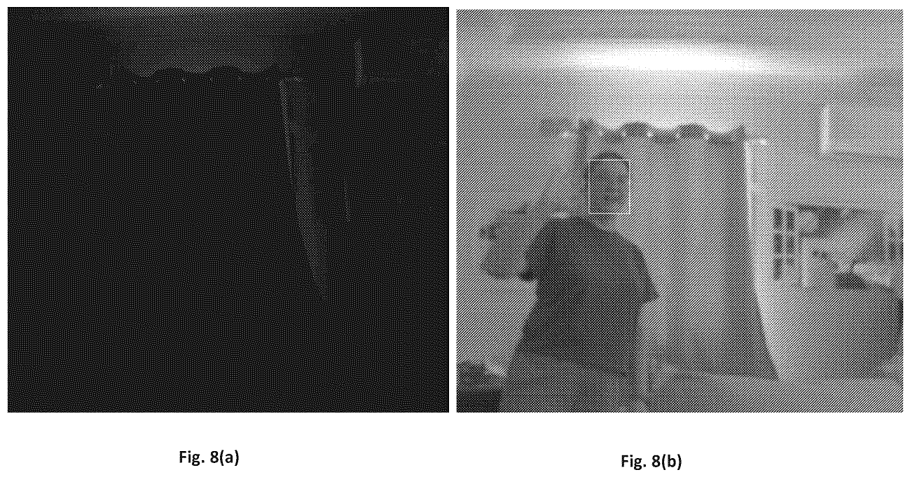

FIG. 8(a) shows an image acquired indoors under low light, using an imager without the enhancement device. FIG. 8(b) shows a low light image taken with an imager with the enhancement processing model. Details previously invisible due to the dark contrast can be seen in the enhanced image of FIG. 8(b).

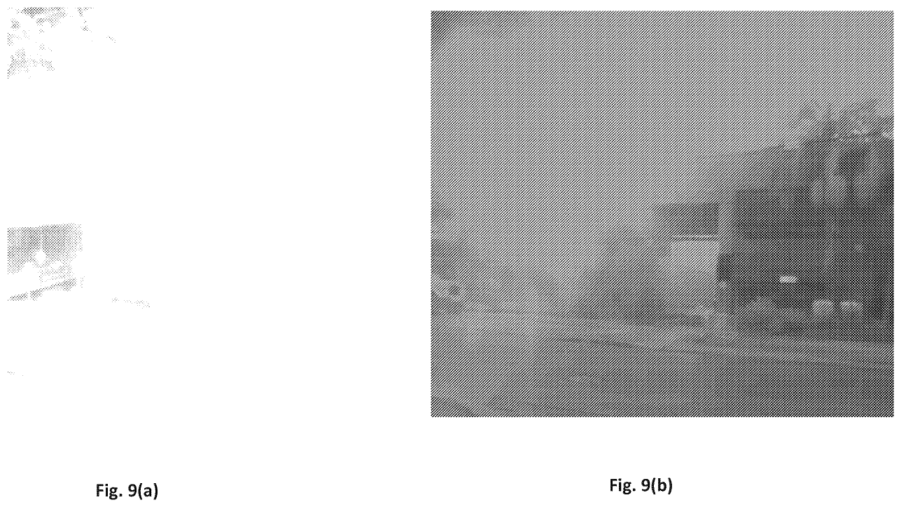

FIG. 9(a) shows an image acquired under bright light using an imager without the enhancement device. FIG. 9(b) shows a bright light image taken using an imager with the enhancement processing model. Details previously invisible due to the oversaturation of the bright light can be seen in the enhanced image of FIG. 9(b).

The results shown in FIGS. 7, 8, and 9 demonstrate that the use of the enhancement device improves the dynamic range of the image sensor to which the enhancement device is coupled. Image enhancement may be done in low signal-to-noise situations, low lighting or saturated lighting conditions. The enhancement provides a high-speed processing for image enhancement to provide a real-time response, without requiring a change to the image sensor equipment itself. This contrasts with existing solutions, e.g., for enhancing low-light images in real time, where specialist hardware or image capture equipment is required. In contrast, the herein disclosed device may be built with off the shelf imaging and digital (or analogue) processing components.

The image enhancement device in accordance with an embodiment of the present invention, implementing temporal processing on the spatial data of the pixels across multiple pipelines, provides the following advantages:
1. for hardware implemented embodiments, image enhancement using digital hardware which can provide real-time enhancement for the hardware implemented component(s), and/or software image enhancement with improved efficiency;
2. Ability to operate at a greater range of frame rates, e.g., at over 90 FPS, the actual frame rate limits being dependent on external limiting factors such as camera speed and processing resources rather than by the algorithm;
3. Ability to operate on full-HD images;
4. Integration with standard, off-the-shelf machine learning algorithms;
5. Implementation of an image enhancement model in each pipeline, where in each pipeline the model operates on a per-pixel (2 bytes) basis rather than on a per-frame basis. This reduces latency of processing and improves memory efficiency. Therefore, with multiple pipelines the reduction of latency is obtained but without commensurate penalty, e.g., in the form of memory or processing resource requirements;
6. The processing of the pixels can be done with a single pipeline up to an N-pipeline. This means that that m pixels (1<=m<=N) pixels can be simultaneously processed at a time. The limiting factor on this is the memory bandwidth.
7. By processing m pixels simultaneously, it is not necessary to wait on the processing of up to N pixels, this allows the pipeline to proceed at minimum latency;
8. The value of m should be an integer so that each pipeline processes an equal area of the frame. This improves statistical coverage of each frame;
9. By processing pixel-wise we always are within the frame-rate by selecting m optimally;
10. For hardware implementations, the algorithm can be adapted to different types of hardware based on timing and latency constraints, meaning low-power higher latency versions of the algorithm can be used in cost-constrained systems.

The power consumption requirement for using the herein disclosed image enhancement device is lower compared with FPGA systems or software solutions that utilise spatial processing to process whole frames. Also, the reduced computational and power requirements mean that the solution according to the present invention can be scaled more easily.

### Other Applications

The pipeline-based approach can be applied more generally to process other types of input data in multiple processing pipelines where temporal processing occurs. Its application is not limited to just the bio-inspired processing mentioned above. Its application is also not limited to processing of image data. Thus, the presently proposed methodology can be applied to enhance other types of inputs than image data. The type of signal data which can be input to the processing pipelines can characterise various types of information.

### Single Time-Series Input

For example, the pipeline-based approach may be applied to a single series of input data that varies over time, such as an audio signal, radio frequency (RF) signal, ultrasonic signal, or any other data where the signal value can change over time. Further examples of the data include measurement data such as temperature, or even other types of data such as stock prices, and so on. Signals from the single series are sent to separate channels, each channel providing the data for a processing pipeline.

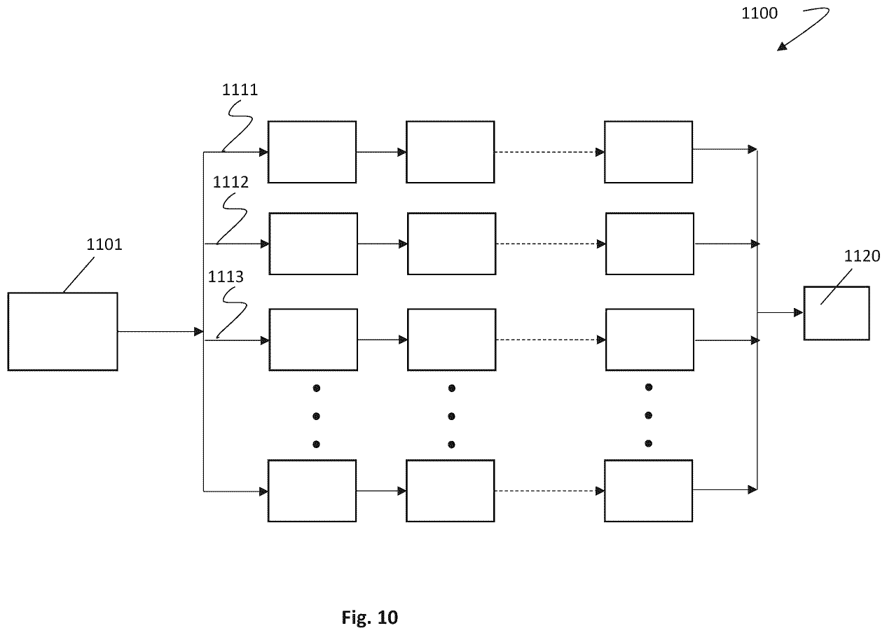

FIG. 10 schematically depicts an example “m pipeline” structure 1100 for a time-series of inputs. Here, the data from the time series 1101 are directed into m separate processing pipelines 1111, 1112, 1113 . . . etc of a processing device provided in accordance with the present invention. Outputs from the separate pipelines 1111, 1112, 1113 . . . etc are recombined at a recombination module 1120 to provide the output for the processing device. The manner of transmitting the signals from the input source into the different pipelines can be devised by the skilled person. For example, the time series of input may be directed by a plurality of switches corresponding to the plurality of processing pipelines, in order to direct different portions of the times series of signals into the pipelines.

In an embodiment, each processing pipeline comprises a cascade of processing stages, each stage being a filter. That is, the processing pipeline comprises a plurality of filters arranged in series, where the input to each subsequent filter is the output of the previous filter. The filters perform both the conversion to the frequency domain and the nonlinear compression that improves the signal-to-noise ratio (SNR). This is similar to the above-mentioned biologically-inspired processing model operating on two-dimensional spatial signals. In essence, each filter creates a virtual “pixel” that describes the frequency content of the signal at a particular point in time. The number of filters to be used depends on the specific application and the results desired to be achieved, and can be selected by the skilled person. E.g., it depends on the frequency range which is desired to be covered, or the desired sensitivity to frequencies (coarse/fine division of frequency changes). For example, in the embodiment processing a sonar input, it may be desired for the processing pipelines to cover a narrower range of frequencies, whilst using a finer difference between the processing ranges of the different pipelines or modules within each pipeline, or both. This method helps to get a better picture of the acoustic signature in the sonar signal.

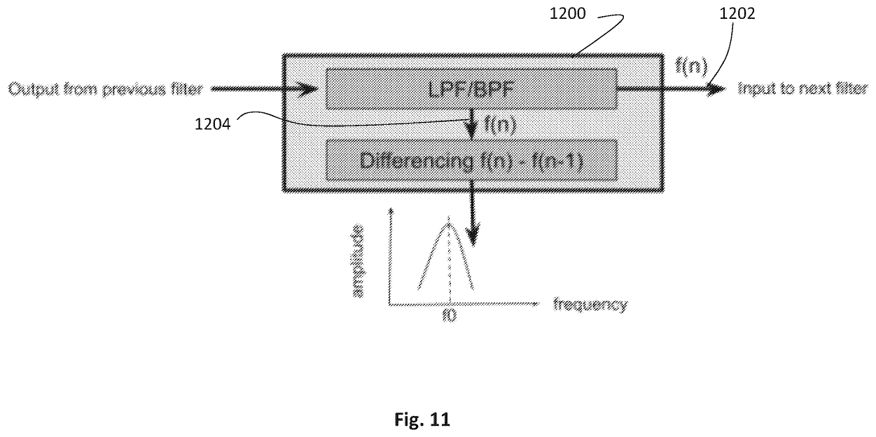

FIG. 11 shows an example of the function of each “virtual pixel”. In FIG. 11 the filter 1200 (providing the “virtual pixel”) includes an operation which low-pass filters (LPF) or band-pass filters (BPF) the input. At each filter, the output f(n) from the filtering operation at the nth time step provides the input to the next filter, as represented by arrow 1202, unless the present filter is the final filter in the cascade. It also provides the input to a frequency domain differencing operation, which subtracts from the current output f(n) the output(s) of one or more of the previous time steps, as represented by arrow 1204. The value being subtracted from the current output f(n) may be from 1 time step up to p time steps prior to the current time step, depending on desired response. The resulting output of the differencing operation is the magnitude of the signal at the best (corner) frequency of the filter.

The differencing operations from the stages of the multiple pipelines thus provide frequency domain information at different frequencies for each signal. Each processing stage could therefore be conceptualised as a “virtual pixel” on a spectrogram. Outputs of the differencing operations from each “virtual pixel” may be used for further processing. The specific processing or algorithms applied to the results from the differencing operations will depend on the practical application or particular parameter being determined, and can be chosen by the skilled person. For example the resulting data approximate a “spectrogram” can be used to detect therein particular frequency signatures of interest.

In an example where the multiple pipelines each provide a cascade of filters, the frequency cut-off is at a highest frequency for the first filter at the start the of cascade, which performs the first filtering of the data in the pipeline, and subsequent filters have progressive lower frequency cut-offs, with the last filter at the end of the cascade having a lowest frequency cut-off.

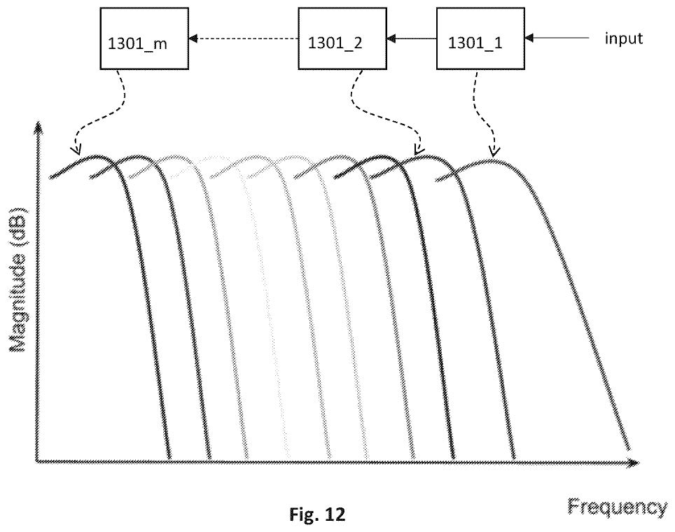

In the aforementioned cascade, a high-order response is achieved as the signal moves through the filter (note that the signal moves from left or input side to right or output side in FIG. 10, and moves from right to left in FIG. 12). This allows the cascade to collectively produce an improved frequency selectivity compared with having a single filter.

Thus, the cascade is similar to a 1-dimensional silicon cochlea and the higher-order response improves the selectivity of the frequency transformation beyond a standard Fast-Fourier Transform (FFT), without the high computational complexity of a traditional FFT operation. The improved frequency selectivity achieved through applying a cascade of filters is shown in FIG. 12. A benefit of this approach is also that the FFT is performed in the pre-processing model, i.e., the multiple pipeline. This lessens the requirement for FFT computations in the digital signal processor.

A drawback of the “silicon cochlea” is that each filter in the silicon cochlea adds a delay in the signal path. This may significantly restrict the spectral range over which the transformation can take place without losing the ability to process the signal in real-time.

Embodiments of the multiple pipeline approach proposed herein can mitigate the delay problem, by improving the processing spectral range or spectral sensitivity. For example, in some embodiments, each processing pipeline process the data in slightly offset frequency cut-offs, thus improving sensitivity.

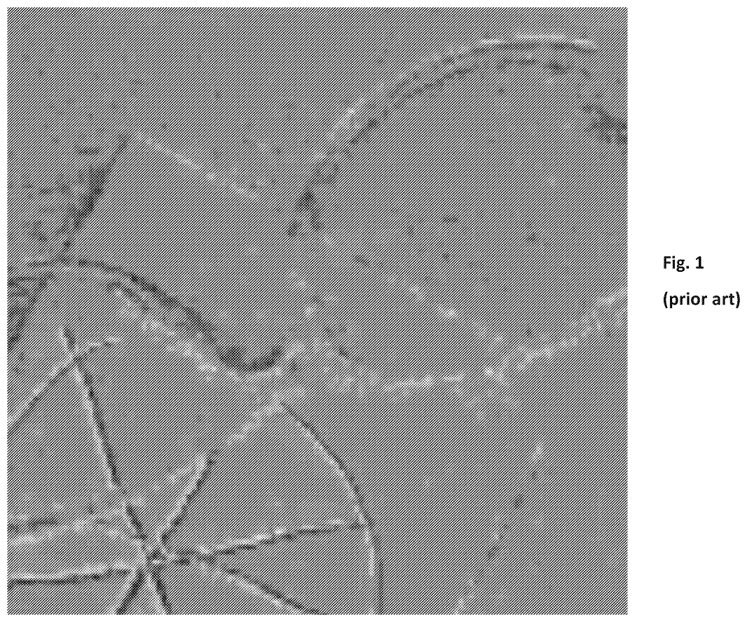

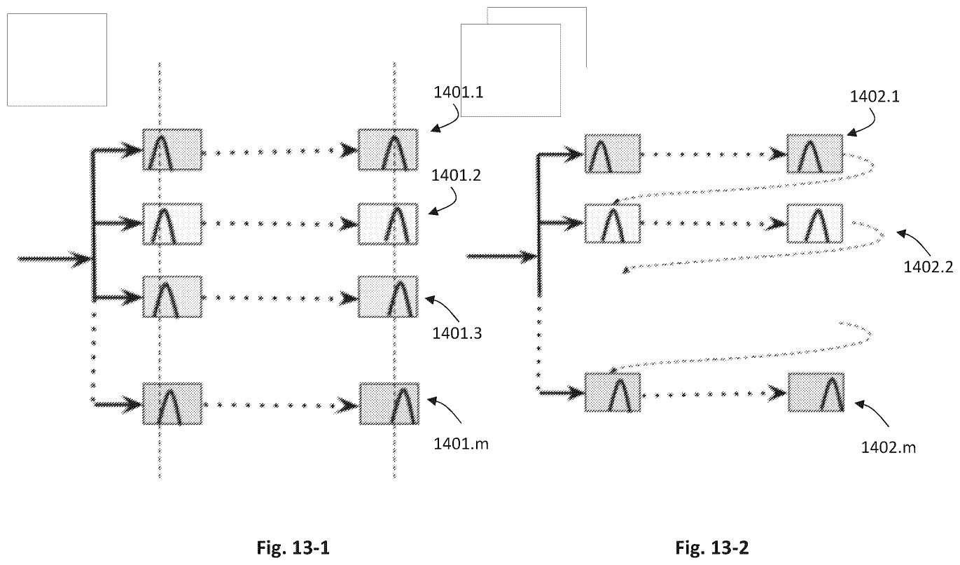

An example is depicted in FIG. 13-1. Referring to FIG. 13-1, each pipeline 1401.1 . . . 1401.m includes the same number of filters arranged in series, i.e., a cascade. The range of cut-off frequencies in each cascade is slightly offset from the rages of cut-off frequencies in the other cascades. Put otherwise, the range of each filter cascade will partially overlap with at least one other filter cascade. More particularly, correspondingly positioned filters across the different cascades will have cut-off frequencies that are slightly offset from each other. That is, each of the first filters of the multiple cascades will have a cut-off frequency slightly offset from the cut-off frequencies of the remaining “first filters”. The same applies to the second filters, third filters, etc.

In a different embodiment, the overall spectral range could be extended across some or all of filter cascades in the multiple pipelines, as depicted in FIG. 13-2. In this arrangement, the filter cascades, rather than having spectral ranges that partially overlap as in FIG. 13-1, have frequency ranges that continue from each other, to provide an extended frequency range. The continuation is conceptually represented by the dashed arrows linking between the cascades. For instance, the dashed line 1402 between the cascades 1402.1 and 1402.2 means that the frequency range of the cascade 1402.2 generally continues from the frequency range of the cascade 1402.1.

The above approaches may be combined. For instance, in an embodiment of a multiple pipeline-based method and device, some cascades may have spectral ranges that overlap, and one or more cascades may have spectral ranges that continue from the range of one or more other cascades. The overlap can be used to provide more sensitivity for particular frequency range or ranges, whereas the spectral range continuation extends the spectral response range.

The pre-processing thus allows for the tuning of frequency responses—i.e., enhancing the output by the subsequent digital signal processor for particular frequencies or frequency ranges. This can be useful in various applications, such as systems where particular frequencies are favoured or targeted. For instance, the pre-processing can be tuned to target the frequency profiles of particular sounds.

The delay occurring through the cascade can further be utilised to provide spatial information within the data from one or more time-series of inputs.

### Multiple Time-Series Input

The multiple pipeline approach may also be used, when the input is provided by a plurality of input sources. Each input source provides a time-series of single-dimensional signals. For example, the input may be provided with 2 microphones for stereo audio input, or a phased array antenna for radio-frequency (RF) and Radar signals, or pixels of a LiDAR system. The use of phased array systems or time of flight systems such as LiDAR also implies spatial processing as the output from these systems are associated with location data such as spatial coordinates. The multiple pipeline approach can be applied similarly to the case of two-dimensional spatial signals (such as from an image sensor). For instance, the pattern of the assignment to the pipelines can be as shown above in FIG. 2.

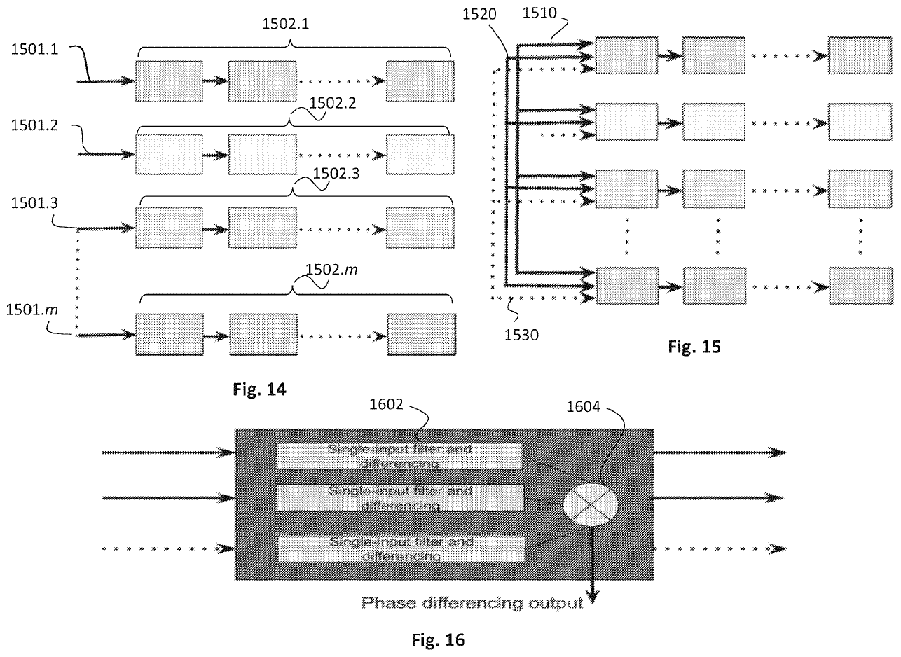

In the example shown in FIG. 14. Here, data from a plurality of input sources are sent to a plurality of processing pipelines. The time-series from each input source may be sent to one pipeline or multiple pipelines. The data series 1501.1, 1501.2, . . . 1501.m are respectively sent to processing pipelines 1502.1, 1502.2, . . . , 1502. m.

In alternative embodiments, the multiple time-series of data can be similarly processed as is the case for a single time series input, utilising a cascade of processing stages, but further with coupled filters at each stage in the cascade. The coupled filters allow simultaneous phase information to be extracted to perform tasks such as ranging and localization. Phase information could be extracted per pair (e.g., a vector of phase differences), or could be extracted between a specific pair (e.g. first and last antenna). An example is shown in FIG. 15. In FIG. 15, each time series 1510, 1520, 1530 represents a times series of input, there being three series of inputs. Data from each series is sent to the same set of multiple processing pipelines. That is, each pipeline receives data from all three series. Each pipeline includes a cascade of filters.

In further examples, the approaches shown in FIG. 14 and FIG. 15 may be combined. In the combined approach, data from at least one of the input sources are sent to a single processing pipeline, whereas data at least another one of the input sources are sent to multiple pipelines. The person skilled in the art will be able to determine, based on data contexts and applications, which individual or combined approach would be most useful.

FIG. 16 depicts an example of the operations performed at each stage in a cascade. Here, each stage in the cascade comprises a plurality of filters, each operating on input data from a corresponding one of the input series. From each stage, the outputs from the filters of that stage are sent to the next stage in the cascade. Also, a differencing operation 1602 is performed on the output for each filter in the stage, to subtract a previous output of the filter from the current output of the filter, where the previous output may be the output of the filter from one or more time-steps earlier. Each input thus passes through corresponding filter and differencing operations as described with reference to FIG. 11, at each cascade stage. At each stage, the filters within the stage are considered to be “coupled”, as the results from the differencing operations 1602 on each input series are combined at operation 1602, via the differencing operation between at least one pair of the filters, to provide a phase differencing output reflecting the phase difference between that pair of filters. Define all pairs, or some possible pairs, or just one pair. The outputs from the differencing operations at each stage can be utilised as inputs for further algorithms, as can be chosen by the skilled person depending on the specific application.

The multiple processing pipeline approach thus enhances the original input from the input source (image sensor, audio sensor, etc), and in this sense is considered an enhancement device. It can be provided as a module to pre-process the data for a downstream processor (e.g., digital signal processor) and lessen the computational load on the downstream processor. It could be added to or integrated with the data sensors, with the signal processor processing the sensor data. The modular nature of the approach allows the processing model to be combined with other types of processing, and could be incorporated within an existing processing system, program, or application. For instance, as alluded to earlier in this document, the debayering or demosaicking, and the colour space correction, could be part of an existing application with which the currently described pre-processing model is combined.

The multiple pipeline approach where each pipeline implements a temporal processing to process data which are captured in a successive nature (i.e., at different time instances), can be used to determine temporal information within the data of a single pixel (in image processing). Thus, it not only speeds up the processing by the use of multiple pipelines, the processing is also enhanced as discussed above.

Specific embodiments of the enhancement device can implement various temporal, spatial, or spatial-temporal processing. The type of processing is chosen so that the enhancement device may be suitable for different types of inputs, as mentioned above in this specification.

It should be noted that a recombination module will be provided to recombine the processed temporal portions of the audio data to provide enhanced audio data or audio stream having a better SNR, when the signal processing is provided as an audio enhancement.

However, recombination is not required in all embodiments. For example, where the inputs are sonar or radar signals, it is the frequency domain outputs from each of the processing modules that provide the required data for further processing. In this case the frequency domain outputs of the processing modules, either at the end of the processing pipeline for each module, or from each stage of the processing module, or both, will be directly provided for further processing. The further processing may be provided by a downstream DSP.

The processing applied by the processing algorithm is not limited to those mentioned above. However generally the processing in each pipeline will be nonlinear signal processing such that the data undergoes signal-to-noise enhancement. Non-linear processing, as mentioned herein, generally means a non-linear output response to the input intensity, as illustrated in FIG. 17. This utilises the temporal properties in the data which is processed by each pipeline, i.e., by accessing memory to obtain data from the previous time step(s) for the pipeline. Changes in the data magnitude (e.g., pixel intensity, audio signal magnitude, magnitudes at particular frequencies of radio data or sonar data, etc) which are small are magnified with extra gain, while large changes are compressed by applying thereto a gain of less than 1 so as to avoid saturation at the output. The output magnitude 1702 thus will asymptotically approach a set level 1704 as the change in input magnitude (determined by comparing the properties of the samples at different time points) is increased. Note the change in data magnitude in FIG. 17 is the absolute change.

The exact form of the nonlinear response, i.e., tangential slopes of the response curve at different parts of the curve, is dependent on the particular sensor used to acquire the data, the available dynamic range of the processing circuits, and the overall sensory landscape.

FIG. 18-1 and FIG. 18-2 provide two example response curves used for different sensory environments. As shown in FIG. 18-1, the nonlinear response 1802 to changes in the input can be “broad” for low signal-to-noise sensory environments such as a dark room (image data) or a quiet night (audio data). “Broad” here means there is a larger range of magnitude changes for which a gain of more than 1 will be applied. Alternatively, as shown in FIG. 18-2, the non-linear response 1804 to changes in the input can be more compressive for high signal-to-noise sensory environments such as bright sunlight which saturates photodiodes (image data) or a loud concert which saturates a microphone response (audio data). The more compressive response means that there is a smaller range of input magnitude change for which the gain will be more than 1.

Preferably, these changes in nonlinear response curves are adaptive over time and facilitated dynamically through changes in its time-constant and operating point.

This nonlinear response aims to approximate responses found in biological cells such as retinal cells, outer hair cochlea cells, touch cells, and other non-mammalian sensory cells. The action of this nonlinear response is to enhance the signal that is provided to the downstream processing of the brain. In the context of the pipeline, the enhancement standalone by improving the SNR of images or sounds or can be a pre-processing step that is followed by further digital signal processing or machine learning.

Variations and modifications may be made to the parts previously described without departing from the spirit or ambit of the disclosure.

For example, the enhancement processing, in hardware implementation embodiments may be implemented using ASICs (application specific integrated chips) as an alternative to FPGAs. The ASIC may be either digital or analogue. It can alternatively be implemented in software using processing units or computing architectures currently available, e.g., as a software application or a cloud application.

As mentioned above, in the case where the processing is applied to image data, the data from each pixel is sent to the assigned pipeline for processing. This means that the embodiments of the processing mentioned herein do not rely on all the pixels in a frame or in a pipeline being available at the same time. Rather, one or more pixels can be updated at a time. This also implicitly means that there is no particular order in which the pixels must be processed. In embodiments where the processing involves software implementation by a software application or a cloud application, the pixels may be provided from a source or multiple sources to the software application, in manners as can be achieved given currently available data acquisition, communication or transfer methodologies. This can cause the pixels to arrive in an ad hoc fashion. There are different scenarios that can cause the ad hoc arrival.

For example, currently available data communication or transfer may not always be consistent. E.g., at slower speeds the transfer rate of the pixels may be lower and sometimes the speeds may not be consistent. The data may also be transferred in dis-ordered packets (e.g., in ethernet transmission), in batches or there may be another cause for an ad-hoc transfer, such as on the basis of a trigger event that causes the transfer.

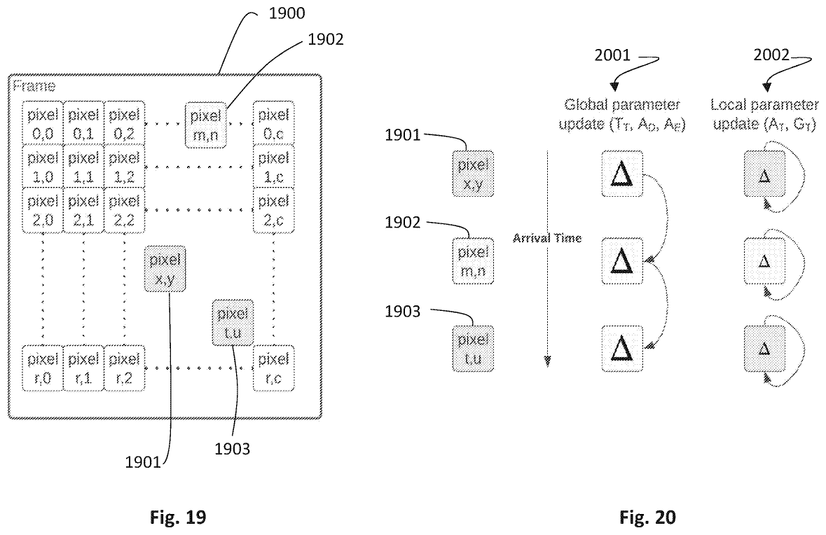

FIG. 19 is a conceptual illustration that pixels within a frame can arrive ad hoc, sequentially, non-sequentially, or out of order, or in a manner described by two of more of these characteristics. In the illustration, pixels from a frame 1900 of c columns and r rows do not all arrive for processing in order as a single frame. In this example, pixels 1901, 1902, 1903, respectively at positions (x, y), (m, n) and (t, u) are delayed and arrive at times t+1, t+2, and t+3 respectively, whereas the other pixels in the frame arrive at time t.

Referring to FIG. 20, the global parameters 2001 describing the global dynamics of the image data for the frame (e.g., global influences on the image data, such as those arising from global lighting conditions, sensor settings or limitations, global movement in the sensor(s) etc) are still computed at each time point and thus will be updated at times t+1, t+2, and t+3, with the successive arrivals of each of pixel 1901, 1902, and 1903. On the other hand, the local parameters 2002 describing the local dynamics will be updated for the respective pixels themselves but not refreshed to reflect the arrival of other pixels. That is, e.g., the local parameters for pixel 1901 are updated when that pixel arrives and is processed, but are not caused to be updated again by the arrival of pixel 1902 or pixel 1903.

The parameters depend on the processing which is being done. For example, according to the processing model 600 shown in FIG. 5, they include the time constants A_{D}, and A_{E} respectively used at the divisive filter stage 610, and the exponential filter stage 615. These are the local parameters. Global parameters include the time constant T_{T} at the temporal filtering stage 605, the adaptive time constant A_{T} and adaptive gain G_{T} used at the temporal filtering stage 605.

Therefore, as depicted, pixels that arrive at the processing unit first can be processed first. The processing outputs from these pixels, i.e., the enhanced pixels, can be available first. This can result in an output frame which appears to have different ones of its pixels become enhanced as the enhanced output pixels become available. This can also result in a refreshing of the frame by the updating of the global parameters. Such refreshing of the frame would be computationally expensive and may not necessarily be implemented. Thus, given the processing described herein, the order in which the pixels arrive and are processed does not matter. Also, the processing described herein is able to deal with images batches of 1 pixel, 2 pixels, 3 pixels, . . . all the way to N pixels where N is the total number of pixels in the frame. The batches can be sequential or non-sequential. Also, some pixel data may be lost (e.g., due to a bad transmission or a problem with network or connectivity) and this loss will not necessarily lead to a significant loss of the image quality of the enhanced image. Optionally, when the signals or data arrive in sequential batches, the associated metadata (e.g., in the case of pixel this may include the x, y coordinates for the pixel) are omitted for all but the first pixel. This is advantageous in that it reduces the amount of data needed for each pixel transmission.

As already mentioned, the methodology of the present invention is applicable to other types of data than image data. It will be understood by the skilled person that the same principles mentioned above will also apply to these other types of data, where different portions of the data may be processed at different times.

The processing described herein can be useful for enhancing data from satellites. Satellite data can sometimes be downloaded as a jumble and may come at different times or have data portions dropped. Further, in some embodiments, a gridding algorithm or an interpolation (e.g., multivariate) algorithm may be provided at the output end of the pipeline(s) to generate a “current” output frame that includes the enhanced pixels and other pixels based on the enhanced pixels. This is useful when the data transfer rate is low. This “current”, i.e., interim, output generated on the basis of available enhanced pixels, may be provided for a live preview to be displayed.

As mentioned earlier, the processing model performs processing including temporal processing—i.e., processing involving samples from different points in time. Often, in practical scenarios, the arrivals of the time samples which are processed are not linked to a particular frame rate or even a consistent rate of time between samples. Accordingly, embodiments of the processing described do not necessarily operate continuously or at a consistent rate. For instance, in a surveillance scenario, the input data may be provided at variable times, or may not be provided continuously, or both. The input data may be provided at variable rates. This may be due to factors such as different frame rates from different sources, changing frame rates, network congestion or availability, variability in data upload speed, data download speed, or both. The surveillance data may only be acquired at particular time(s) of the day, or when certain conditions are met. Examples of conditions include but are not limited to the detection of heat or movement, the detection of an “event” in image data.

As another example, in situations where data transmissions (e.g., from satellites) are not reliable the image data may arrive for the processing at non-continuous or variable times. In these and other scenarios, the input data will not necessarily be synchronised to continuous times according to a clock, i.e., the data in the case of images may be single images with possibly variable time between pixels, or video with variable times between pixels or frames.

Therefore, in some circumstances the input will be provided to the algorithm at variable times, and the algorithm will process the input as data becomes available. Accordingly, the output may be updated as the latest input data becomes available and is processed. This variable time update is particularly useful when data is collected using drones or satellites where the surveillance area is monitored when the drone/satellite is available and weather/other conditions are acceptable for the images to be gathered. Processing the data as the data becomes available means the processing may be performed at a lower rate and power consumption.

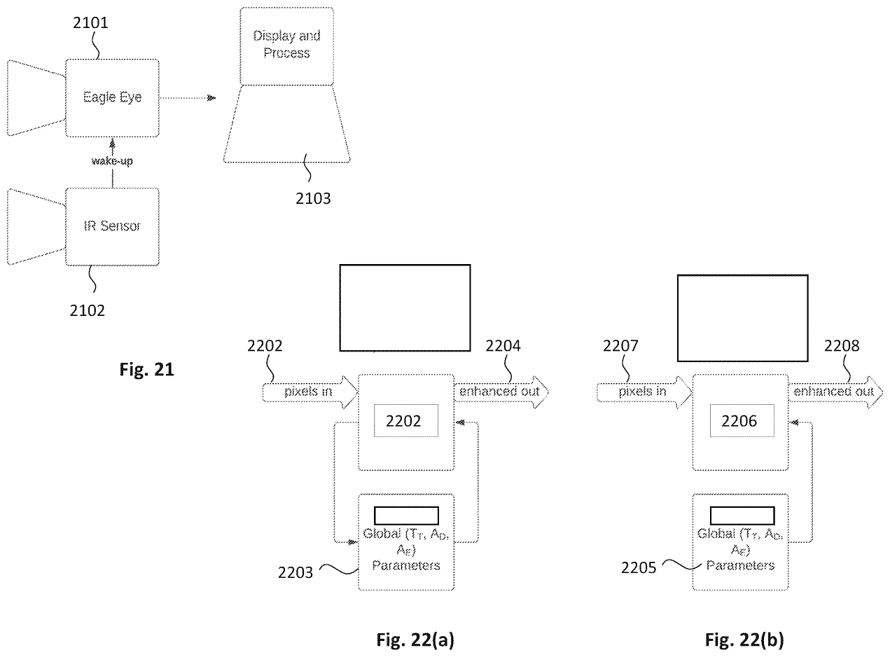

For example, FIG. 21 schematically depicts an arrangement where the camera 2101 does not operate continuously. Rather it is caused to “wake-up” by movement detection, which may be via the use of an infrared sensor 2102. The data from the camera 2101 is only provided to processing device 2102 for processing of the image data. The processing device 2102 in the depicted embodiment also displays the enhanced image but this is optional. Other mechanisms that trigger the “wake-up” can be used. For example, the wake-up may be on the basis of an event-based image detection to detect of-interest events. The choice as to how to “wake-up” the camera may be dependent on the specific application. The as-needed or scheduled nature of the data acquisition means the processing is also not continuous, i.e., at potentially variable times.

In some scenarios, the input data is acquired under generally static conditions, such as in an environment with fixed lighting. The input data may be acquired under conditions which can be changed from time to time but remain generally static between changes, such as in an environment where the level of lighting is switched between different levels. Some fixed cameras acquire input data under these types of conditions. Examples of environments where this would be appropriate include but are not limited to, medical imaging, fixed position camera inside or with known time-of-day operating conditions, indoor surveillance such as indoor assembly line surveillance, etc. Pre-learning the global parameters can reduce latency and power consumption of processing.

Embodiments of the processing discussed herein may be implemented to process data expected to be acquired in generally static conditions. In these implementations, the calculations of the enhancement parameters will be made only once, or only when the conditions change. This helps to reduce the amount of processing overhead.

For example, FIGS. 22 (a) and (b) schematically depicts a two-stage processing. During a calibration period, the global parameters associated with the input (e.g., global across whole frame or all sensing arrays, etc), are learned. The example depicted in FIG. 22 is in the context of image processing. As shown in FIG. 22(a), data acquired during the calibration period is used to learn the global parameters to be applied during the period of static conditions. The input pixels 2201 are provided to the algorithm 2202, which calculates the global parameters 2203, i.e., parameters describing the global dynamics across the frame. The global parameters computed on the basis of previous inputs are fed back to the algorithm 2203 so that they may be updated when new input pixels 2202 become available. This feedback and updating continue until the end of the calibration period. Enhanced outputs 2204 from the algorithm 2202 may be provided. The calibration period may be set as a predetermined period of time, or as the period as required for the algorithm to process a predetermined number of frames. The calibration period may be automatically concluded on the basis of a stabilization of the global parameters, e.g., when the global parameters computed have stabilized. As shown in FIG. 22(b), after the calibration period, the global parameters 2205 obtained at the end of the stabilization period are used as inputs to the algorithm 2206 which is the same as algorithm 2202 except it takes the calibrated global parameters 2205 as inputs rather than calculating global parameters on the basis of the input 2207. In the post-calibration period, the enhanced outputs 2208 are determined with the global parameters set at their calibrated values. The pre-learning of the global parameters during the calibration period can further reduce latency and processing resource requirements during the post-calibration period, until a re-calibration is required. Re-calibration may occur on the basis of a scheduled change in the environmental conditions, or in response to a sensed change in the environmental conditions, e.g., in response to a light sensor sensing a change in lighting levels or in response to a switching action or report of a switching action. The sensed change may need to be above a threshold amount in order to cause the re-calibration. During or after the calibration period, the input provided 2202, 2207 may be subject to issues such as the variable times between frames or pixels, variable latencies or dis-ordered arrivals as mentioned earlier, e.g., with reference to FIGS. 20 to 21. The acquisition of the input 2207 provided during the post-calibration period may be subjected to “wake-up” requirements as described earlier, e.g., with reference to FIG. 19. The acquisition of the input 2202 during the calibration period also may be subjected to a “wake-up” requirement, as can be set by the skilled person, as long as this does not negatively affect the calibration of the global parameters.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

It should also be appreciated that features discussed in relation to the various figures may be combined. As an example, in relation to FIG. 14, inputs 1501.1, 1501.2 may each be provided to identical pipelines 1502.1, 1502.2 having the same frequency response range, and input 1501.3 may be provided to the two or more of the remaining pipelines, pipelines receiving signals from the same input source can have a frequency range structure shown in FIG. 13-1 or FIG. 13-2. Other combination as can be devised by the skilled person, in accordance with the principles disclosed herein, may be made.

### Existing Hardware Solutions

Existing hardware implementation of image enhancement may be based on FPGA (Field Programmable Gate Array). One proposed solution in presents an FPGA implementation of 3 image enhancement algorithms: brightness control, contrast adjustment, and histogram equalization. The results show near-real-time performance, however, the frame size was restricted to 100×100 images and the results were shown for still images rather than real-time processing of video images.

Another proposed solution presents an FPGA image enhancement system design for use on resource-constrained UAVs (unmanned aerial vehicles) that uses Approximate Computing to reduce the computational complexity of the system and thereby reducing power consumption and size. However this does not focus on enhancement algorithms and real-time performance.

In another prior art solution, retinex filtering is implemented along with glare reduction. Retinex filtering is based on a bio-perceptually-inspired model that set out to explain the perceived colour constancy of objects under varying illumination conditions. The FPGA implementation has been shown to work at a maximum rate of 60 frames per second (fps) and on images with resolutions of 1920×1200 (full HD). The performance of the haze reduction and retinex filters is comparable with other implementations that have been performed in software or lesser-performing hardware implementations. The drawback of this approach is that it requires processing over the entire frame. The spatial filtering means there is a requirement for a large memory read/write access to filter the image frame.

One image enhancement system in presents both low-light and haze image correcting techniques based on an adaptive histogram algorithm. The performance of the system is impressive across the dataset generated by the authors. However, this system is not real-time and is extremely computationally intensive. The device is capable of processing 30 fps in full-HD (1920×1080) video using an Intel Cyclone V FPGA. Additionally, as with Retinex filtering, adaptive histogram algorithms are based on spatial filtering techniques that require processing over the entire frame.

Another system utilises a real-time, biologically-inspired FPGA-based image enhancement algorithm based on the human vision system (HVS). The algorithm uses spatial information to enhance an image and remove glare and improve contrast in low-light environments. The FPGA implementation worked with images of up to 25M pixels and 25 fps.

Compared with the prior art, embodiments disclosed herein, in digital hardware implementation, improves speed and performance without massive computational overheads.

The present approach further allows the bio-inspired algorithm to have software implementations and still improved speed and performance.

The number of FPGA image enhancement systems is large with the above examples only scratching the surface of the widebody of literature in this field. To the Applicant's knowledge, however, no published system has included real-time, 90+ fps, and accounted for both glare and low-light enhancement.

A category of neuromorphic image systems described includes Dynamic Vision Sensors (or Event-Based Cameras). Dynamic Vision Sensors (DVS) also known as Event-Based Cameras/Sensors (EBC or EBS) have been developed based on the neuro-biology of the mammalian eye. The DVS is a custom-built imager that incorporates change detection hardware into each pixel. Thus, the pixels in a DVS camera only output when changes in light intensity are detected. This means that the camera is also not capable of sending frames but rather outputs “events” which are digital packets that contain information on which pixel changed, whether it is a positive or negative change and the time at which the change was detected. The event-based data must then be processed by a custom algorithm which, depending on the required timing accuracy, needs to be able to handle extremely high-speed data in order to be competitive with standard frame-based cameras. The advantages of DVS cameras, however, are their enormous dynamic range and low power requirement. For example, the image shown in FIG. 1 is a screen-shot of a YouTube video (source: https://www.youtube.com/shorts/5NNoq1Gq4sc; accessed 17 May 2022), that shows how a pair of sunglasses does not affect the contrast in the detected image when using a DVS camera.

The drawbacks of DVS cameras, however, include the fact that they are blind when nothing in the image is moving (or when everything is moving) and the requirement for specialised hardware or software in order to process the data. FIG. 1 illustrates an example image obtained using a DVS camera. The image shows items including a pair of sunglasses. However, looking through the sunglasses did not affect the contrast of the image. In fact, the sunglasses appear to be clear from the image.

Embodiments described here achieve a similar dynamic range without these drawbacks.

It is to be understood that, if any prior art is referred to herein, such reference does not constitute an admission that the prior art forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-47. (canceled)

48. A signal processing system comprising:
a plurality of processing modules, configured to receive signal data comprising at least one input stream of data, wherein each module is configured to receive a respective one of a plurality of portions of the signal data, so that the plurality of processing modules together process the received signal data;
the plurality of processing modules being configured to apply processing to a respective one the portions of the signal data, and provide a processed result as an output;
wherein each processing module is configured, in use, to apply processing including temporal processing to its corresponding portion of the signal data; and
wherein each processing module in use applies processing which improves a signal to noise ratio of its respective processed portion of the signal data.

49. The system of claim 48, further comprising a recombination module to recombine processed signal data output by the processing modules.

50. The system of claim 48, wherein the plurality of processing modules are identical.

51. The system of claim 48, wherein each processing module comprises a plurality of processing stages connected in series.

52. The system of claim 48, wherein the input are image data comprising one or more frames having pixels, and each separate portion of signal data includes data of a set of pixels, the set of pixels comprising one or more pixels at the same locations in each frame.

53. The system of claim 52, wherein each separate portion includes: pixels distributed across each of the one or more the frames.

54. The system of claim 53, wherein:
signals corresponding to the pixels of the frame are provided to the plurality of processing modules in turn, where a first pixel in the frame is provided to a first one of the processing modules, and each subsequent pixel is provided to a subsequent one of the processing modules in turn; or
for each frame in the image data, the separate data portions processed by different processing modules are signals of neighboring pixels.

55. The system of claim 52, wherein one or more of the plurality of processing modules is or are configured to process one pixel at a time.

56. The system of claim 55, wherein outputs from the one or more processing modules configured to process one pixel at a time are enhanced pixels, and are provided as partial outputs as they are generated.

57. The system of claim 55, comprising an output module configured to generate an output frame comprising the enhanced pixels.

58. The system of claim 48, being further characterized by one or more of the following:
processing applied at each processing module includes frequency domain processing;
each processing module includes at least one processing stage configured to apply a low pass filter or a band pass filter;
each processing module comprises a cascade of filters connected in series.

59. The system of claim 48, wherein the signal data is received from multiple data sources, wherein every processing module is configured to receive data from each of the multiple data sources.

60. The system of claim 59, wherein each data source is configured to provide a time series of data, and each processing stage comprises multiple filters, respectively operating on data from a corresponding one of the data sources.

61. The system of claim 60, wherein: the filters in the same processing module have a same cut-off frequency; or the filters in different processing modules have different cut-off frequencies; or both.

62. The system of claim 61, wherein:
the plurality of processing modules have frequency response ranges which continue from each other to generally form an extended frequency response range; or
at least one of the plurality of processing modules has a frequency response range which overlaps with a frequency response range of another one of the plurality of processing modules; or
at each processing stage, a filter output at a previous time sample is subtracted from a filter output at a current time sample.

63. The system of claim 48, wherein the common source provides signal data having variability over time.

64. The system of claim 63, wherein the data source can be any one of sources comprising image sensor(s), phased array, antenna(s), audio sensor(s), radio frequency sensor(s), ultrasound sensor(s), inertial sensor(s).

65. The system of claim 48, wherein the temporal processing for each of the plurality of processing modules is configured to determine, on the basis of its corresponding portion of the received signal data, values of one or more global parameters characterizing a global dynamic in the received data.

66. The system of claim 65, wherein the temporal processing for each of the plurality of processing modules is further configured to determine values of one or more local parameters characterizing a local dynamic in the corresponding portion of the received data processed by the processing module.

67. A method for processing signals, using a signal processing system, the signal processing system comprising:
a plurality of processing modules, configured to receive signal data comprising at least one input stream of data, wherein each module is configured to receive a respective one of a plurality of portions of the signal data, so that the plurality of processing modules together process the received signal data;
the plurality of processing modules being configured to apply processing to a respective one the portions of the signal data, and provide a processed result as an output;
wherein each processing module is configured, in use, to apply processing including temporal processing to its corresponding portion of the signal data; and
wherein each processing module in use applies processing which improves a signal to noise ratio of its respective processed portion of the signal data, the method comprising:
enabling a data connection between an input source and the signal processing system, so that each of a plurality of different portions of an input signal data will in use be received by a corresponding module of the plurality of modules in the signal processing system to be processed by the module;
combining outputs from the plurality of modules to form recombined frames.
